(19) United States
(12) Patent Application Publication
(10) Pub. No.: US 2017/0185712 A1
(43) Pub. Date: Jun. 29, 2017

(54) A METHOD OF STORING/RECONSTRUCTING A MULTITUDE OF SEQUENCES IN/FROM A DATA STORAGE STRUCTURE

(71) Applicant: Genalice B.V., Harderwijk (NL)

(72) Inventor: Johannes KARTEN, Harderwijk (NL)

(21) Appl. No.: 15/302,377

(22) PCT Filed: Feb. 6, 2015
(86) PCT No.: PCT/NL2015/050078

§ 371 Date: Oct. 6, 2016

(30) Foreign Application Priority Data
Feb. 6, 2014 (NL) 2012222

(51) Int. Cl. G06F 19/28; G06F 17/30

(52) U.S. Cl. CPC G06F 19/28; G06F 17/30321; G06F 17/30516

(57) ABSTRACT

The invention relates to a computer implemented method of storing/recovering in/from a storage data structure a multitude of sequences that have been aligned with a reference data structure. The information of the sequences is stored in different sections. Each section comprises data streams comprising specific data of the sequences having a reference position in the reference position range associated with the data stream. In a first section, the length of the sequences is stored. In a second section, the mutations of a sequence with respect to the reference sequence are stored. In a third section, consensus based quality values are linked with positions in the reference sequence. In a fourth section, the sequence identifiers are stored. The storage data structure has a format which is optimized for viewer, re-alignment, variant calling and other post-processing tools.

### TECHNICAL FIELD

The invention relates to a computer implemented method of storing in a data storage structure a multitude of genetic sequences that have been aligned with a reference data structure. The invention further relates to a computer implemented method of reconstructing from a data storage structure a genetic sequence that have been aligned with a reference data structure.

### BACKGROUND

Alignment is the process of mapping reads or pair-end reads on a reference based on the pattern of the read. A read is one sequence of elements wherein each element has one of the values A, C, G and T. A pair-end read comprises two sequences of elements, wherein one of the two sequences is a “plus strand” or “forward strand” and the other, the mate, is a “minus strand” or “reverse complement strand”. The number of reads which stream from a sequencer varies depending on the read size. A high end sequencer can produce 120Gbase per day in short reads of 75, 100, 150 or 200 bases. The size of such stream is in the order of 300Gbytes. The data is stored in for example a FASTQ file.

Current alignment tools generate a SAM file. A SAM file is a tab-delimited text file that contains sequence alignment data. To reduce the size of the results, the SAM file is converted in a BAM file which is the binary version of a SAM file including an index.

In a BAM file, all the reads, which could be both mates of a pair-end read, are stored in the order of matching position. The order of position is essential to display with reasonable response times the alignment results with a viewer and to perform variant calling. However, to perform a re-alignment of the sequences stored in the BAM, it is desired that in case of pair-end read, both sequences are supplied simultaneous to the alignment process. Recovering the pair-end read from a BAM file requires a lot of time as the coupling between mates is ‘soft’. To find the mate of a particular read, another part of the BAM-file has to be read and decompressed to find the read with the corresponding sequence identifier.

US2006/112264 discloses a differential compression method which combines hash value techniques and suffix array techniques. In a delta file matching substrings between two files are described as tokens. There are two kinds of tokens, reference file tokens and delta file tokens. The reference file tokens store the length of the match and the location of the start of the match in the reference file. Delta file tokens store the length of the new substring to be added. A delta file comprises three different streams of data: 1) the token information stream (which provides information about whether a matching substring is described as a delta file token or a reference file token along with the length of the matching substring), 2) the reference file offset stream (which tells where the matching substring starts in the reference file), and 3) the delta information (the substrings that need to be added). The document does not disclose how a multitude of genetic sequences has to be stored in one data structure. US2013/0185267A1 discloses methods and systems for compressing and comparing genomic data. The method comprising selecting a segment, creating a delta representation of the segment. The delta representation comprises a script. The script is stored. A substring of the segment that are found in the reference may be encoded as copy commands, where the elements of each block to be copied may be described by the start position on the reference and the length of the string to be copied. Substrings not found in the reference are encoded as insert commands in which the delta string to be added is explicitly represented. A reconstruction algorithm can rebuild the original segment by repeatedly copying substrings (specified by their coordinates) from the reference, and adding literal substrings specified by the delta string. Delta compressed DNA sequences are stored in a database using the I/D/S representation. The database comprises a segment table, a variant table, an operation table and a string table. References are used to link the data from the tables to enable to obtain the necessary data to reconstruct an original segment. A multitude of database lookups are necessary to reconstruct a segment. Retrieving segments aligned with a particular range of positions on the reference would require that the entire database has to be processed. This will be very time consuming and makes the database structure unsuitable for online/real-time analyses and inspection/visualization of characteristics of multiple stored segments having substrings that matches the same part of the reference.

### SUMMARY

It is an object of the invention to provide an improved method of storing/recovering in/from a storage data structure a multitude of sequences that have been aligned with a reference data structure, which overcomes at least of the disadvantages described above.

The reference data structure describes reference data as one contiguous reference sequence wherein each element of the reference sequences has a position number and element value. A sequence comprises a number of elements with element values that matches a part of the reference sequence. The part of the reference sequence having a corresponding reference position on the reference sequence.

According to a first aspect of the invention, this object is achieved by a method having the features of claim 1. Advantageous embodiments and further ways of carrying out the invention may be attained by the measures mentioned in the dependent claims.

The improved method comprises: storing a first parameter in a header section of the data storage structure. The first parameter identifies the reference data structure. In a first storage section of the storage data structure data about the reference position and the number of elements for each sequence of the multitude of sequences is stored. In a second storage section of the storage data structure mutations of the multitude of genetic sequences are stored. In the first storage section comprises a multitude of first storage section records are stored. A first storage section record is associated with at least one sequence which has a corresponding reference position. The first storage section record further comprises a length field with a value which enables to determine the number of elements of the at least one sequence. The method further comprises counting the sequences having the same reference position to obtain a count value and generating a data stream by concatenating the count value and the first storage section records corresponding to the genetic sequences that have the same reference position.

The invention is based on the insight that about 95% of the reads that have to be aligned with a genome have a perfect match with the reference data sequence. A perfect match can be reconstructed from the reference data sequence if a start position on the reference data sequence is known and the length of the sequence is known. As the reference data sequence is always available in a reference data structure for further processing, only a linkage to the reference data structure is necessary in the data storage structure to enable retrieving element values from specific reference positions. By storing only the reference position of a sequence and the length of the sequence/read the memory footprint is reduced significantly.

To address a position in a genome with 3.2 bases, at least 32 bits are necessary. By grouping the sequences with the same reference position, the storage footprint to store all reference position can be reduced further.

In an embodiment, the data corresponding to the multiple of genetic sequences is ordered in the first storage section and second storage section by the reference position of the genetic sequences. This feature enables to retrieve efficiently all sequences aligned with a specific range of positions on the reference sequence as not the entire first storage section and second storage section has to be read and processed but only the contiguous part of the storage sections having data of sequences having a reference position in said specific range.

In a further embodiment, the position numbers of the reference sequence are segmented in non-overlapping blocks with a position range of S position numbers. The method generates for each block that has at least one sequence with a reference position in the position rang of said block a data stream wherein a course presence indicator and a fine presence indicator is present in the data stream before a first storage section record. The fine presence indicator indicates for each of F subsequent reference positions the presence of at least one sequence, the course presence indicator indicates for each group of C subsequent groups of F subsequent reference positions the present of at least one sequence in said group of F subsequent reference positions and wherein S=F×C. With these features, the storage footprint for storing the reference positions of the multitude of sequences is reduced further. Assume S=256, F=8 and C=32. To identify the presence of at least one sequence on each of the 256 reference positions, now only 32+32×8 bits are needed. To store 256 individual addresses for the sequences 256×32 bits would be necessary. In the given example a storage footprint reduction of about 96.5% is achieved.

In an embodiment, the position numbers of the elements of the reference sequence are segmented in non-overlapping sections with a position range of P positions. The method further comprises generating a first storage section index. An index entry is generated for each section of P positions that has at least one sequence with a reference position in its position range. A segment data stream is generated which comprises the first storage section records of the sequences having a reference position in a section of P positions. The segment data stream is stored at an address in the storage data structure. The address is assigned to the entry of the index corresponding to the section of P positions. These features enables reducing the response time to recover the reads that have a reference position at positions of the genome that have to be studied, analysed, re-aligned or has to be used in Variant Calling. The index provides direct access to the address in the first storage section comprising a desired range.

In a further embodiment, the method comprises: determining for a segment data stream the position of the sequence having the lowest reference position and assigning a relative position value corresponding to the lowest reference position to the entry of the index corresponding to the section of P positions. These features reduce the footprint of a segment data stream for a section as no data has to be stored for the part of the segment with reference positions before the lowest reference position. This is important for partial genome sequencing such as exome- or panel-sequencing

In an embodiment, the method further comprises: storing a second parameter in the header section of the data structure, the second parameter enabling to obtain a value for a basis length of a sequence; and wherein the number of elements of a sequence corresponds to the value of the basis length minus the value of the length field. These features reduce the storage footprint to store the length values.

In an alternative embodiment, a record in the first storage section further comprises a first format field prior to the length field for storing a first parameter identifying the number of bits of the length field. These features reduce the storage footprint to store the length values.

In an embodiment, the method stores a first sequence and a second sequences which form a pair of sequences. A first storage section record is generated which comprising a first length field, a second length field and a gap field. The first length field and the second length field contain a value defining the number of elements of the first and second sequence respectively. The gap field has a value defining the distance between the reference position of the first sequence and the reference position of the second sequence. These features are advantageous for re-alignment of pair-end reads.

According to a further embodiment, the method further comprises: generating an additional first storage section record for the second sequence in the segment data stream of the section of P positions comprising the reference position of the second sequence if the reference position of the second sequence is located in another section of P positions than the section of P positions associated with the reference position of the first sequence. This feature is advantageous for performing Variant Calling processing on the sequences in the data storage structure. All reads that have been mapped in a particular segment of the genome could be reconstructed from the data in the respective sections associated with said segment.

In a further embodiment, the additional first storage section is preceded by a format field and a length field, and the combination of a predefined value of the format field and a predefined value of the length field indicates that the following data is an additional first storage section record. The combination of format field and length field enables to represent some values with two different formats, i.e. number of bits. By using one of the two value with a specific format as indicator, the length value can still be used but in the other format. The value with the format that represents the indicator indicates that the read length that follows is from a mate of a pair-end read.

In an embodiment, if the contiguous sequence of elements of the reference data structure does not have a sequence part of elements that fully matches a sequence the method comprises: storing for the sequence in a second storage section of the storage data structure a second storage section record. The second storage section record describes the sequence in terms enabling to reconstruct the element values of the sequence by retrieving the element value of the elements that have a matching position in the reference data structure from the associated position in the sequence of reference data structure and the element values of the elements of the sequence that does not have a matching position from the second storage section record. Contrary to what is expected, the separation of the storage of the length information of the multitude of sequences and the storage of the mutations of the sequence with respect to the reference sequence results in a reduction of the storage footprint. By using an index structure to read the data streams associated with a particular segment, the increase in time to reconstruct the sequences is negligible.

In a further embodiment, the second storage section record comprises a first field identifying the position of a mutation in the sequence and a second field identifying the type of mutation. The second storage section record comprises a third field containing the quality of the elements which value differs from the reference. This allows reducing further the storage footprint.

Each element of a sequence has a quality value. In an embodiment, the method further comprises: determining for each position number of the reference data sequence the highest quality value of the elements of the multitude of sequences that has been mapped on said position number. A third storage section with an index is generated that enables retrieving the highest quality value for each position number from the storage section. It has been found that upgrading the quality of some elements of a read by assigning the higher quality value of the element of another read that is mapped on the same position in the reference sequence does not degraded the re-usability of the reads for re-alignment. It has been found that this increases the re-usability.

A quality value could have four different values and the position numbers of the reference sequence are segmented in non-overlapping blocks with a position range of Q position numbers. In a further embodiment, the method further comprises for each block of Q position numbers that has at least one element of the multitude of sequences mapped on the position range: determining the most common quality value; generating a first data structure identifying all positions having the most common quality value; generating a second data structure identifying all positions not having the most common quality value and the lowest quality value; generating a quality value stream identifying the quality values of all positions not having the most common quality value and the lowest quality value; and storing in the third storage section a stream of data that is a concatenation of a field with a value representing the most common quality value, the first data structure, the second data structure and the quality value stream. These features reduce the footprint to store the quality values.

Each sequence of the multitude of sequences comprises a sequence identifier. In an embodiment, the method comprises: storing the sequence identifiers in a fourth storage section that differs from the first storage section. Separating the storage of the sequence identifiers in a separate section decreases the time to retrieve the sequence information which is necessary for certain post-processing which do not need the sequence identifiers.

A sequence identifier is a string of characters with fields that are separated by a delimiter. A field is one of two types, a first type represents a string of digits, and a second type represents a string of characters with at least one letter. In a further embodiment, the method comprises: generating a lookup table comprising at least one entry with a template describing the field types of the fields of a sequence identifier and entries for each of the different values of the second type fields. For a sequence a fourth storage section record, a fourth storage section record is generated which comprises a first field with a pointer to the at least one entry with a template describing the field types of the sequence identifier and a number of next fields specified by the template retrieve from the al least one entry of the lookup table, a next field identified by the template as first type field contains a number corresponding the string of digits and a next identified by the template as second type field contains a pointer to the entry of the lookup table comprising the string of characters with at least one letter. These features reduce the storage footprint for storing the sequence identifiers.

According to a second aspect, there is provided a computer implemented method of reconstructing a sequence that have been aligned with a reference data structure from a storage data structure generated with the method according to any of the previous embodiments. The sequence comprises a number of elements having an element value; the reference data structure describes reference data as one contiguous reference sequence wherein each element of the reference sequence has a position number and element value. The method comprises: reading a first parameter from a header section of the data structure, the first parameter identifying the reference data structure; retrieving from a first storage section of the storage data structure a reference position of the sequence on the reference data structure; retrieving a length value from a length field of a first storage section record, the value enabling to determine the number of elements of the sequence; and, retrieving the values of the elements of the sequence by reading a part of the contiguous reference sequence which position is defined by the reference position and which length is defined by the length value.

According to a third aspect, there is provided a computer implemented system comprising a processor, an Input/Output device to connect to the network system, a database and a data storage comprising instructions, which when executed by the processor cause the computer implemented system to perform any of the methods described above. There is further provided a computer program product, a processor readable medium and a database product comprising a storage data structure generated by any of the methods described above.

Other features and advantages will become apparent from the following detailed description, taken in conjunction with the accompanying drawings which illustrate, by way of example, various features of embodiments.

### BRIEF DESCRIPTION OF THE DRAWINGS

These and other aspects, properties and advantages will be explained hereinafter based on the following description with reference to the drawings, wherein like reference numerals denote like or comparable parts, and in which:

FIG. 1 illustrates an example of the general structure of a data storage structure for storing a multitude of sequences that have been aligned with a reference data structure;

FIG. 2 illustrates the data structure of the read index;

FIG. 3 illustrates an exemplary embodiment of a data stream in the read section;

FIG. 4 illustrates the data structure of a read section data record;

FIG. 5 illustrates the data structure of a stream in the Call section;

FIG. 6 illustrates the data structure of a Mutation Data record;

FIG. 7 illustrates the data structure of a quality section;

FIG. 8 illustrates an example of a data structure to store position data;

FIG. 9 illustrates the data structure of an annotation section data record;

FIG. 10 illustrates the data structure of an annotation section data record;

FIG. 11 is a block diagram illustrating a computer implemented system; and,

FIG. 12 illustrates an example of a read and corresponding reference data.

### DETAILED DESCRIPTION

Alignment is the process of mapping random reads on a reference data structure based on the pattern of the read. The number of reads which stream from a sequencer varies depending on the read size. A high end sequencer can produce 120Gbase per day in short reads of 75, 100, 150 or 200 bases. The size of such stream of bases generated by a sequencer is in the order of 300Gbytes. After alignment the reads have to be stored for further processing or re-alignment. Further processing could be and is not limited to analysing the result of alignment and display the result on a display screen.

The reference data structure use for alignment could comprise the data of a genome. A genome exists of 4 different nucleotides or bases which form a string. The codes for these nucleotides are referred to in literature A C G T. These strings are connected where AT and CG form pairs. In the present application, the bases are encoded using two bits: 00 [symbol] −A; 01 [symbol] C; 10 [symbol] G and 11 [symbol] T. A human genome exists of 3.2Billion base pairs. With an encoding of 2 bits per genome position, the description of the entire genome can be stored in −750 Mb. The genome is a combination of a number of chromosomes of the DNA. In a FASTA file, which is commonly used to store a genome as reference data, each chromosome is described in a section of the FASTA file.

In the present application, a sequence is a sequence of bases, for example a read generated by a sequencer, and a reference data structure is a data structure which includes the genome that is used as reference during the matching process. Each element value of the sequence has a quality value, which is an indication by the sequencing machine about the reliability of the value. A reference data structure is used which describes reference data as one contiguous reference sequence. Each element of the reference sequence has a position number and an element value. After the matching process a sequence for which at least a part with a minimal size could be matched on the reference data structure will have a corresponding matching location. There is a match when the subsequent element values of a part of the data sequence are identical to a subsequent part of the element values of the reference sequence.

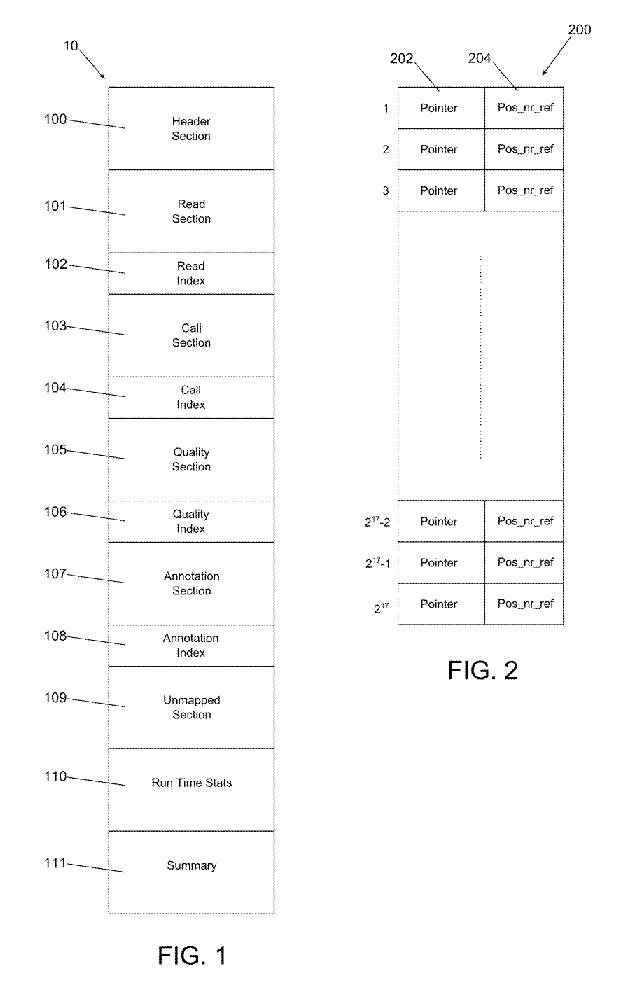

FIG. 1 illustrates an example of the general structure of a data storage structure 10 for storing a multitude of sequences that have been aligned with a reference data structure. The structure allows storing efficiently the element values of all reads generated by a sequencer, if present matching positions of the elements on the reference sequence and quality information related to each of the element values. The structure further allows reconstructing all reads that match a particular part of the reference sequence. It is not necessary to process the entire data storage structure, to retrieve only the reads of said particular part.

In the following description of the method the term “element” refers to a single base having a value A, C, G or T.

The basic concept of the method to store the data of reads is that the element value of an element of a read that has a match doesn't have to be saved as the value could be retrieved from the reference sequence. The reference sequence is always stored for future alignments. The general structure in FIG. 1 shows the sections that form part of the data storage structure.

First a short description will be given of the sections of the data storage structure. Thereafter, sections will be described in more detail with reference to corresponding Figures.

The header section 100 comprises general information about the stored data for example information about the reference data structure and information about the program that generated the storage date structure. The information about the reference data structure is used to link the data storage structure to the reference data. The information about the program that generated the data storage structure could provide the program that recovers the reads from the data structure information about parameters which define the data format. It should be noted that these parameters could also be stored in the header section directly. Furthermore, the header section comprises a parameter indicating whether single reads or pair-end reads are stored in the data storage structure.

The read section 101 and read index 102 comprises information about the length of the reads and the position of the read on the reference data sequence. The read section 101 is the first storage section. The position of a read is determined from information stored in the read index 102 and information stored in the read section 101. The length of each read that has at least one relevant matching part on the reference sequence is stored in the read section 101. A relevant matching part is a sequence of elements with a predefined minimum length and optionally the quality of the elements is higher than a predefined minimum quality value. A predefined minimum length could be 20 If the reads are from pair-end sequence files, the length of the reads that form a pair-end and that have both at least one relevant matching part are stored together in a first storage section record.

The call section 103 and the call index 104 comprise mutation information of the reads with respect to the reference data sequence. Furthermore, it comprises, if present, quality information of the elements that does not have a matching position in the reference data sequence.

The quality section 105 and the quality index 106 comprise the quality value that is assigned to each element of the reference sequence based on the matching results of the alignment process of the multitude of reads. Each element of a read has obtained a quality value from the sequencing machine. The quality value indicates the reliability that the element value given to the element is correct. The quality value that is assigned to an element of the reference sequence corresponds to the quality value of the element of a read that matches the element of the reference sequence with the highest quality value. As a consequence of this the quality value of the elements of a read that is recovered from the data storage structure could have a higher value than originally assigned by the sequencing machine. However, this is acceptable as the quality value of an element will only be higher if there is another read which has an overlapping matching part which element has a higher quality value. As those reads have a matching part at the same location on the reference sequence, it is clear that the highest quality observation applies to the element value as the reads proof thru consensus that the element value of the elements having a particular matching position in the reference sequence has indeed the given element value.

The Annotation section 107 and annotation index 108 link to each read which length is stored in the read section a sequence identifier and an optional description. These parts of the data storage structure enable to recover reads in their original FASTQ format. After recovering only the quality value of elements could differ from the original quality value that was assigned to the element by the sequencer.

The unmapped section 109 comprises the data of the reads that did not match with the reference sequence. In case the data storage structure stores a multitude of pair-end reads this section comprises two parts. In a first part all data of the reads that did not match but which mate did match is stored. In this part, to each record describing a read information is added that links the read to its mate which is described in the read section. This could be done by adding the reference position of the mate on the reference sequence and its index number indicating to which of the reads having the same reference position it is linked. For recovering the reads of a pair-end it is advantageous to store the unmapped reads in this part in the order of the reference position of the mates. In the second part all data of the reads is stored which did not match and if the reads are pair-end reads also its mate did not match. Pair-end reads are preferably stored as pair.

The Run Time Stats section 110 comprises information about the matching process of the reads. Information that could be stored is the amount of reads processed per time unit.

The summary section 111 provides coverage information of the aligned sequences on the reference data sequence. The coverage information comprises for each element of the reference data sequence the number of times an element of a read is mapped on the position of said element.

In case the data storage structure is one large file, the read index 102 is preferably stored after the read section 101. This also applies to the other sections. The main reason for this is that read index comprises links to addresses in the read section, which are known after generating the read section. In this way, the file could be generated without overwriting previously generated file parts on the storage medium, for example a hard disk.

FIG. 2 illustrates the data structure 200 of the read index 102, the first storage section index. The read index shown in FIG. 2 comprises 2¹⁷ entries. The read index could be in the form of a table with 2¹⁷ rows and two columns. Each entry comprises a first field 202 and optionally a second field 204. A pointer 202 to an address in the read section is stored in the first field. A position number on the reference 204 is stored in the second field. A reference data sequence of a genome of a human comprises 3.2Gbases. The 2¹⁷ entries are used to segment the reference data sequence in segments of equal size of 2¹⁵=32k bases. The first entry with index number 1 covers the positions 0-32767, the second entry with index 2 covers the positions 32768-65535, etc. The lengths of the reads or the pair-end reads having a reference position number in the range of an entry are stored as one stream of data in the read section 102. Preferably, the element having a matching position which has the lowest position number in the reference data sequence is used to indicate the reference position number. The pointer 202 of an entry points to the address in the read section where a stream with all reads having a reference position number in the range of positions on the reference sequence starts. The second field 204 is used to store a value to determine the position number on the reference data sequence when reading the data stream which starts in the data storage structure at the address indicated by the first field 202. The value of the second field could be an absolute position number on the reference data sequence or a relative position number in the range which corresponds to the index number of the entry. Sections of 32k positions make it possible to recover reads in a desired range of the reference data sequence in a short period of time. The sections of 32k positions are non-overlapping sections. The number of entries of the read index 102 could be reduced by generating only an entry for a section of 32k bases if at least one read or fragment of a read in case of a break has reference position in said entry. In this case the second column with position number on the reference 204 is essentials as the index number does not provide any more the start address in the 32k range in the reference data sequence. This also applies to all other indexes that will be created for the other data sections.

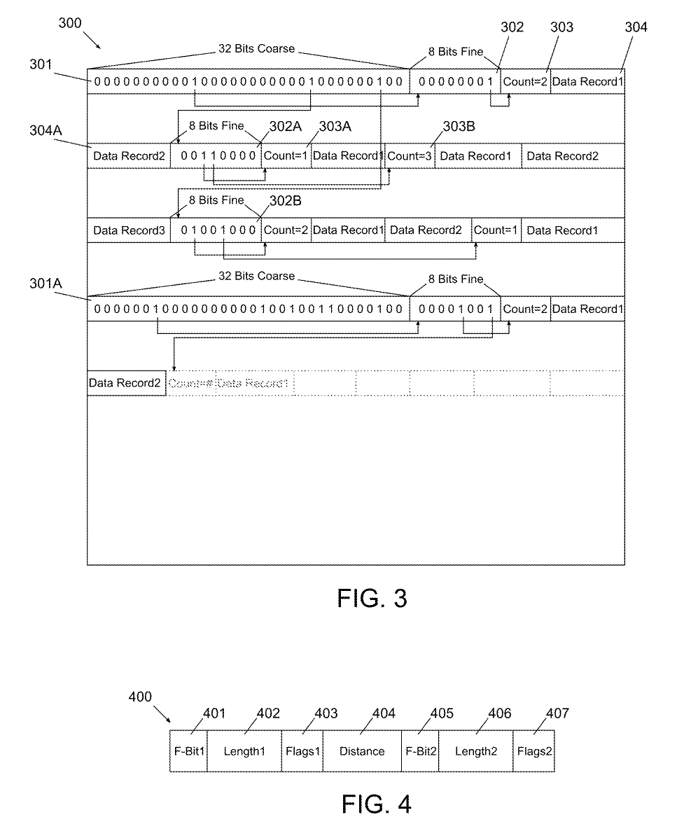

FIG. 3 illustrates an exemplary embodiment of a data stream 300 or segment data stream, in the read section 102 corresponding to an entry of the index. The data stream 300 of an entry of the index enables to retrieve therefrom the reference position number and length of all reads or pair-end reads that have a reference position number in the position range on the reference data sequence defined by the index number of said entry. In the present application an entry corresponds to 32768 (32k) position numbers. The data stream 300 is composed of a series of sub-streams. Each sub-stream enables to retrieve therefrom the reference position number and length of all reads or pair-end reads that have a reference position number in a range of 256 reference positioned numbers on the reference data sequence. The range of a sub-stream starts at a position which is a multiple of 256. The first position of the range of the first sub-stream is defined by the data from the read index 101. The first position of the range of the second sub-stream is 256 higher, etc. Accordingly, a stream 300 for 32K position numbers could comprise a series of 128 sub-streams. The sub-streams segment the position numbers of the reference sequence in non-overlapping block with a position range of 256 position numbers. It might be clear that other sizes of range are also possible.

A sub-stream starts with a first bit-mask field 301 or course presence indicator. Each bit of the first bit-mask field represents a number of position numbers. The number of position numbers depends on the number of bits of a second bit-mask field 302 which is a fine presence indicator. The first bit-mask provides coarse position information, in a range of eight positions, about the location of matched reads and the second bit-mask field provides fine information about the reference position of a read on the reference data sequence. Each bit of the second bit-mask field 302 represents one position number. A bit value “0” of a bit of the first bit-mask field 301 indicates that there is no read or pair-end read with a reference position in the range of position numbers represented by said bit. A bit value “1” of a bit the first bit-mask field 301 indicates that there is at least one read or pair-end read with a reference position in the range of positions of said bit. A bit value “1” is further an indication that a second bit-mask field 302 is present in the stream subsequent to the first bit-mask field 301. If all bits of the first bit-mask field are “0”, the sub-stream has a total length of 32 bits and will be followed by the first bit-mask field of a subsequent sub-stream. The number of bits with a value “1” defines the amount of second bit-mask fields in a sub-stream. The first second bit-mask field 302 is associated with the first bit of the first bit-mask field; the second bit-mask field 302A is associated with the second bit of the first bit-mask field 301, etc.

A bit value of “1” of the second bit-mask field 302, 302A indicates that there is at least one read or pair-end read with a reference position number corresponding to the reference position of said bit. As there is always one bit with a value “1”, the second bit-mask field 302A will be followed by a count field 303A. This count field is associated with the first bit of the second bit-mask field 302 having a value “1”. The second count field 303B after the second bit-mask field is associated with the second bit of the second bit-mask field 302A having a value “1”. The value of the count field 303 is the number of reads and/or pair-end raids that has a reference position at the position number associated with the bit to which the count field is associated. The count field 303, 303A has a value greater than or equal to 1. A count field will be followed by a number of read section data records equal to the value of the count field. The data structure of the read section data records will be described with reference to FIG. 4.

FIG. 3 shows an example of a first sub-stream and the beginning of a second sub-stream. The first bit-mask field 301 of the first sub-stream comprises three bits with a value “1”. Consequently, the first bit-stream comprises three second bit-masks field 302, 302A and 3028. The first second bit-mask comprises one bit with a value “1” and is consequently followed by one count field 303 and a number of read section data records according to the value of the could field, in the present example two.

The reference position number on the reference data sequence of the first data record 304 and second data record 304A is 8 plus 10×8 plus the reference position number from the second field of the entry associated with the stream 300. The number of read section data records in a sub-stream is equal to the sum of all count field values of the sub stream. The number of count fields in a sub stream is equal to the number of bits of all the second bit-mask fields of a sub-stream with a value “1”.

FIG. 4 illustrates the data structure of a read section data record 400 or first storage section record. This data structure is used to store the necessary information to recover the length of a single read or the lengths of both reads of a pair-end and the number of elements between the reference positions of the reads or pair-end reads that have both a match on the reference data structure. To store single read only fields 401-403 are used. From a parameter in the header section is known whether single reads or pair-end reads are stored. The length of a read is the number of elements or bases of the sequence of a read with a minimal quality. Normally, the elements of a read with a quality lower than a predefined level are clipped from the sequence prior to matching. Therefore, the length of the reads does not have a fixed value. This phenomenon is known to the person skilled in the art.

In the length fields 402, 406 the absolute length of a read could be stored. Normally about 95% of the reads that matches have a length in the range of 70-100 when the sequencing machine generates reads with a length of 100 bases. To store a value of 100, the length field should have 7 bits. To store all absolute length of 100 reads 700 bits are needed.

According to an embodiment of the present application a common read length value is stored in a length field of the header section 101, for example the value 100. The difference of this common length value and the length in the length field 402 results in the stored length of the read. This allows a reduction of the number of bits for the reads having a length in the range of 70-100 to five bits. To be able to assign all length outside the range 7 bits are needed. The bits of the length field represent a positive integer. A format bit in a format field is needed to define the number of bits that is used to store the value. When 95% of the reads have a length in the range of 70-100, then 570 bits are needed to store the length of 95 reads and 40 bits are needed to store the length of the 5% reads outside the range. Thus 610 bits are now needed instead of 700 bits. If the format bit indicates that the length field comprises 5 bits, the length of the sequence is obtained by subtracting the value from the common length value. In the format bit indicates that the length field comprises 12 bits, the length of the sequence is the value of the length field. It should be noted that other solution are possible for example the length is determined by summing the value of the length field and the common length value. In this case the five bits of the length field should represent both positive and negative integer values.

Therefore a read section data record comprises a first format field 401 which is format-bit F-Bits1 indicating the number of bits that is used for the first length field 402. A value “0” is used to indicate that the first length field comprises V1 bits and a value “1” is used to indicate that the first length field comprises V2 bits. The parameters V1 and V2 could be defined in the header section 101 or could be defined by identification of the program that generated the data storage structure. This identification is also stored in the header section 101. In an embodiment, V1 is 5 and V2 is 12. A value for V2 of 12 is used to make this concept also suitable for very long reads with an average length longer than 256 and that one method could be used to generate the data store structure. The combination of a format field before a value field wherein value of the format field defines the number of bits of the following value field will be referred to as variable bit length data format.

After the first length field 402, there is a first format field 403. The first format field 403 comprises two bits. A first bit indicates from which of the two files of pair-end sequences files the read is coming and a second bit indicates the order type on how the element values should be reconstructed from the reference data sequence. The order type could be forward or reverse-complement.

In distance field 404 the distance between the reference position of the first read and the second read is stored. In this way pair-end reads could be retrieved efficiently from the data storage structure and less bits are needed to store the reference position of the mate. The information of the read of a pair-end with the lowest reference position is stored in the fields prior to the distance field 404 and the information of the read of a pair-end with the highest reference position is stored in the field after the distance field. 404. The variable bit length data format is preferably used to store the value.

After the distance field 404, the same data structure is used to store the data of the mate. There is a second format field 405, a second length field 406 and a second formats field 407.

If a read does not have a mate that matches on the reference data sequence, the distance field 404 is used to indicate this. When the variable bit length data format is used to store an integer value, some values can be represented in two different formats. By reserving the highest value(s) of the representation with the lowest number of bits as indicator and not using these values as distance value, additional functionality can be added to the distance field.

To store the mutations of the read with respect to the reference sequence, the data storage structure comprises a Call section 103 and a Call index 104. The Call index 104 is an index which divides the position numbers of reference data sequence in a similar manner as the read index 102. However an entry of the index comprises now only a pointer to the start address in the Call section of the stream comprising all mutations of the read having a reference position in the range corresponding to the entry number. It should be noted that frequently, most of the reads, 95%, are a perfect match and only 5% comprises mutations that have to be stored in the Call section.

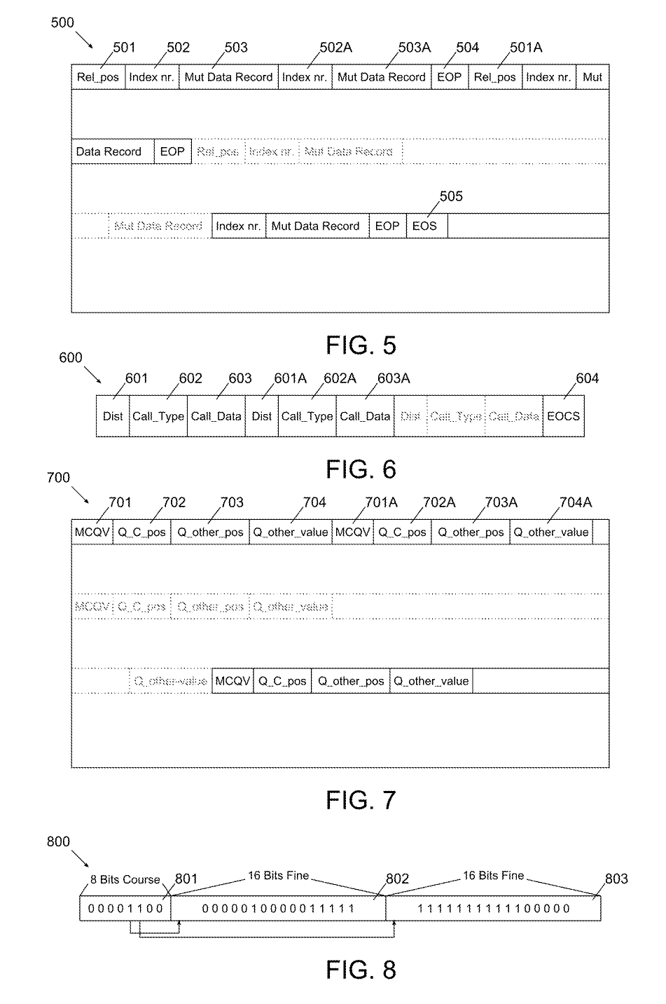

FIG. 5 shows the data structure of a stream 500 in the Call section 103. The stream in the Call section is a concatenation of sub-streams. A stream comprises all mutations of the read having a reference position in a range of 32768 positions. Each sub-stream describes all mutations of all reads or pair-end reads having the same reference position. A sub-stream starts with a position field 501, followed by alternating an index number field 502, 502A and mutation data record 503, 503A and ends with an EOP (end of position) field. The position fields 501, 501A define the offset of the reference position of the reads with respect to the previously known reference position. The value of the first position field 501 of the stream is the offset in position with respect to the first reference position in the range of the associated entry which directed to read the present stream. The value of the second position field 501A in the stream is the offset with respect to the reference position calculated by the first position field 501. The index number field 502 indicates the index number of the reads at said reference position stored in the read section 102. In this way a link is created between the length information and mutation information of a read. The index number field is used as only mutation information of read that does not have a perfect match comprises a mutation data record 503, 503A in the Call Section 103. A stream of the Call section 103 ends with an EOS (End-Of-Stream) field 505. It should be noted that the EOS field 505 could be the EOP field of the last sub-stream in a section. The number of bits of the position fields could be fixed or a variable bit length data format could be used.

In FIG. 5, the first sub-stream comprises mutation information of two reads and the second sub-stream comprises mutation information of only one read.

FIG. 6 shows the data structure 600 of a Mutation Data Record 503, 503A. A mutation Data Record is also a data stream which is a concatenation of one or more sub-streams and at the end and EOCS (End Of Call Stream) field 604. A sub-stream comprises a distance field 601, 601A, a call type field 602, 602A and a call data field 603, 603A.

The distance field 601A defines the offset of the first position of the mutation defined by call type field and call data field with respect to the last position of the previous mutation. The first distance field 601 defines the offset with respect to the reference position of the read.

In the Call type field 602, 602A the type of mutation is stored. The call type field comprises four bits and enables to define sixteen call types. Below a list of call types is given:

| | | |
|---|---|---|
| 0 | UN 1 | |
| 1 | UP X | To indicate that two or subsequent elements of read have |
| | | another values than the values at corresponding positions in |
| | | reference sequence |
| 2 | UP A | To indicate that one element with value A of read has another |
| | | value than the value at corresponding position in reference |
| | | sequence |
| 3 | UP C | To indicate that one element with value C of read has another |
| | | value than the value at corresponding position in reference |
| | | sequence |
| 4 | UP G | To indicate that one element with value G of read has another |
| | | value than the value at corresponding position in reference |
| | | sequence |
| 5 | UP T | To indicate that one element with value T of read has another |
| | | value than the value at corresponding position in reference |
| | | sequence |
| 6 | IN # | To indicate that two or elements are not present in reference |
| | | sequence |
| 7 | IN A | To indicate that one element with value A is not present in |
| | | reference sequence |
| 8 | IN C | To indicate that one element with value C is not present in |
| | | reference sequence |
| 9 | IN G | To indicate that one element with value G is not present in |
| | | reference sequence |
| 10 | IN T | To indicate that one element with value T is not present in |
| | | reference sequence |
| 11 | DEL | To indicate to one or more subsequent elements of reference |
| | | sequence read are not present in read |
| 12 | UNM | To store large sections of a long read that could not be |
| | | mapped |
| 13 | BRK | To indicate a break in the sequence |
| 14 | RID | To couple mutations that follow a read |
| 15 | CLIP | To store initial/end part of data sequence that is not used |
| | | for mapping |

Depending the call type the call data field 603, 603A comprises at least one of length data, a sequence of element values, quality information of the changed or inserted elements, relative or absolute position information.

To store the quality information of the elements of the reads, for each element of the reference data sequence a quality value is determined by means of the quality information of the elements of the read having a matching position and value on the reference data sequence. As the quality value is an indication of the likelihood that a value has the assigned value, the highest quality value is the best estimate of the consensus quality value. Consequently the highest quality value will be stored. In FASTQ files the quality could have an integer value from 0 to 40. It has been found that 4 levels could be used without losing essential information. In the default setting of present application quality values in the range 0-16 are mapped on value 0, the values in the range 17-25 are mapped on value 1, the values in the range 26-34 are mapped on value 2 and the values 35-40 are mapped on value 3. This makes it possible to store just one quality value of two bits for all elements of reads that are mapped on a reference position of the reference data sequence and that has the same element value.

In the quality section 106 to each position of the reference data sequence is assigned a quality value of two bits. The quality section 105 comprises sections of 32k positions similar to the division in sections as the read section and call section. Each section is divided into subsections of 128 reference positions. Consequently, a section of 32k comprises 256 subsections. The Quality index has an index similar to the index of the read section. To reduce the size of the index, only entries are generated for the 32k sections wherein at least one element of a read has a matching location.

FIG. 7 shows the data structure 700 of the quality section 105. It comprises one data stream that is a concatenation of 256 sub-streams. Each sub-stream comprises the quality information of 128 reference positions. A sub-stream comprises four fields, a first field 701, 701A, a second field 702, 702A, a third field 703, 703A and a fourth field 704, 704A. The first field 701 comprises two bits which value corresponds to the quality value unequal to “0” that has the most occurrences in the range associated with the sub-stream. This value is called the Most Common Quality Value MCQV. The second field 702 identifies all positions in the range having a quality value equal to the MCQV. The third field 703 identifies all positions having a value not equal to “0” and the MCQV, thus all other quality values. In the fourth field 704, the quality values of the positions identified in the third field 703 are given as a sequence. In principle one bit is sufficient to identify the value of the other values other than “0” and the MCQV. To increase the retrieving speed it is advantageous to use the representation of the original format of the quality value.

The position data in the second field 702 and third field 703 could be compressed by run-length encoding. FIG. 8 illustrates another embodiment to reduce the amount of bits to store the position data. The data structure 800 is similar to the data structure used in the read section to identify a read at a particular position. The data structure comprises a first part 801 of 8 bits and a second part 802 of 16 times the amount of bits in the first part having a value “1”. The first 16 bits are associated with the first bit of the first part having a value “1”; the second 16 bits are associated with the second bit of the first part having a value “1”. In FIG. 8, the first part comprises two bits with a value “1”. Therefore, the second part comprises 2×16 bits. In the example shown in FIG. 8, position 72 and positions 78-91 are identified.

It should be noted that if a section only comprises “0” the first field 701 could have a value “0”.

In a FASTQ-file all reads/sequences have a sequence identifier. A general example of a sequence identifier is EAS234:6:FC693VJ:1056:17853:204586:1. In general a sequence identifier is a string of characters with fields that are separated by a Colon “:”. The given example comprises seven fields. The fields could represent sequentially: the unique instrument name; the run id; the flowcell id, the tile number within the flowcell lane; ‘x’-coordinate of the cluster within the tile; ‘y’-coordinate of the cluster within the tile; the member of a pair. There are generally two types of fields: 1) string with at least one letter and 2) string with only digits. It has been found that the amount of different values in fields with at least one letter is limited whereas the amount of different values in field with only digits is huge. Furthermore, the number of different formats of a sequence identifier that has to be stored in one data storage structure is limited. Therefore, a special data structure is developed to reduce the amount of storage capacity to store the sequence identifiers.

For each data storage structure a look-up table is generated. In some entries the different formats of the sequence identifiers is store. In other entries the values of the fields with at least one letter are stored. The look-up table could be stored in the header section 100 or in the annotation index section 108. To link the sequence identifier with the read stored in the read section 101 an index structure is used which is similar to the read index structure as shown in FIG. 2. Furthermore, the annotation section has a data structure similar to that of the read section 101 as shown in FIG. 3 and described in the corresponding part of the description. The only difference is the content and format of the Data Record fields 304, 304A in FIG. 3.

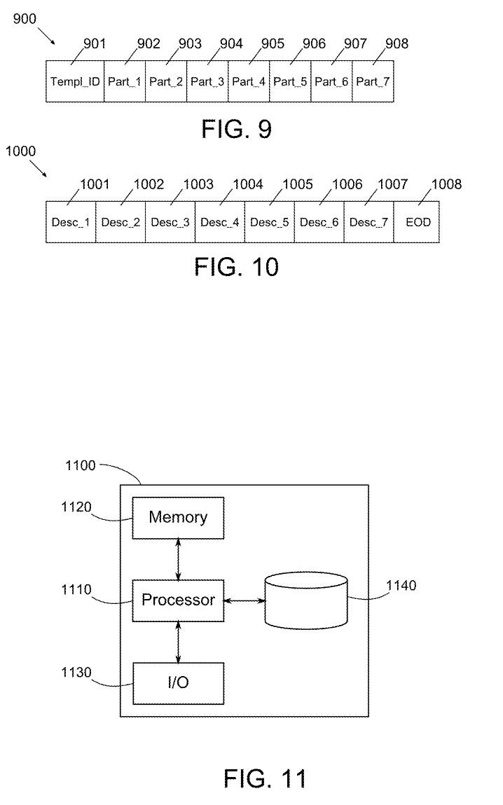

FIG. 9 illustrates the data structure 900 of an annotation section data record. The first field 901 of the annotation section data record comprises a pointer to the entry of the loop-up table which comprises the description of the format of the read_name/sequence identifier for the read/sequence. FIG. 10 illustrates a possible data structure 1000 to describe the format of a sequence identifier. The data structure comprises a number of fields. Each of the fields comprises a value identifying the type of the corresponding field. Given the example of a sequence identifier above, the first field 1001 comprises a value indicating the first data field 902 after first field 901 of the annotation section data record is a pointer to an entry of the look-up table. The entry which comprises the string of characters “EAS234”, which is the first part of the sequence identifier. The second field 1002 comprises a value indicating the second data field 903 after first field 901 of the annotation section data record is an integer value. The integer value could have a variable bit length data format which comprises two fields. The first field, a format field, indicates the number of bits in the second field to represent the integer value. In an embodiment, the first field comprises 2 bits, wherein the values “00”, “01”, “10” and“11” indicates that the second field comprises respectively 4, 8, 16 and 32 bits to represent the integer value. It should be noted that this format could also be used to store a pointer to the look-up table. The third field 1003 comprises a value indicating that the third data field 904 after first field 901 of the annotation section data record is a pointer to an entry of the look-up table. The entry which comprises the string of characters “FC693VJ”, which is the third part of the sequence identifier. The fourth to seventh field 1004-1007 comprise values indicating the fourth to seventh data field 905-908 after first field 901 of the annotation section data record are integer value. The variable bit length data format is used to store the integer values. The last field 1008 in the present example comprises a value EOD (End of Description) to indicate that there are no further parts to describe the sequence identifier.

When the sequence identifier of given example is stored as a string of 36 characters with six Colons separating the seven fields, 288 bits storage capacity is needed. With the described data storage structure the string could be stored in less than 238 bits. Assuming that all values in an annotation record can be represented with 16 bits or less, the 36 characters can be stored in less than 126 bits.

Due to a break or a fusion, it might happen that a read has a first part, initial sequence part, in one section of 32k bases and a subsequent second part, fragment sequence part, in another section of 32K bases, wherein the two sections are not subsequent. For variant calling it is important that all fragments/reads that have a match in a particular section could easily be retrieved from the data storage structure. To enable this, the information to reconstruct the second part from the storage data structure is stored twice in the data storage structure by generating an additional read section data record and if necessary mutation data record. The first time as part of the read in the section of 32k bases wherein the reference position of the read is located, and a second time in the section of 32k bases wherein the reference position of the second part is located. Similarly, it might happen that from a pair-end read, the first read has a reference position in one section of 32k bases and the mate has a reference position in another section of 32k. The mate is than a so-called cross reference read. The information to reconstruct the mate is stored twice in the data storage structure. To enable the second storage of the fragment or mate in a read section data record, the two highest values of the variable bit length format with the less number of bits are used to indicate the type of data that is stored twice. After this special use of fields 401 and 402 of a read section data record, the fragment or mate will be stored with the format as shown in FIG. 4. It should be noted that if a read with a break has a reference position in one section and the part of the sequence after the break is in another section and the mate is also in the another section, the sequence part after the break is stored as a fragment read in the another section and the mate is stored in the another section as an cross-reference read.

Referring to FIG. 11, there is illustrated a block diagram of exemplary components of a computer implemented system 1100. The computer implemented system 1100 can be any type of computer having sufficient memory and computing resources to perform the described method. As illustrated in FIG. 11, the processing unit 1100 comprises a processor 1110, data storage 1120, an Input/Output unit 1130 and a database 1140. The data storage 1120, which could be any suitable memory to store data, comprises instructions that, when executed by the processor 1110 cause the computer implemented system 1100 to perform the actions corresponding to any of the methods described in the present application. The Input/Output unit 1130 retrieves the aligned sequences directly from an alignment process or in the form of a combination of FASTQ, SAM or BAM files. The database 1140 could be used to store the reference data structure and the data storage structure.

The method could be embodied as a computer program product comprising instructions that can be loaded by a computer arrangement, causing said computer arrangement to perform any of the methods described above. The computer program product could be stored on a computer readable medium.

A product of the method of storing a multitude of sequences is a database product comprising a data storage structure and reference data structure. The database product could be in the form of one or more files on a computer readable medium.

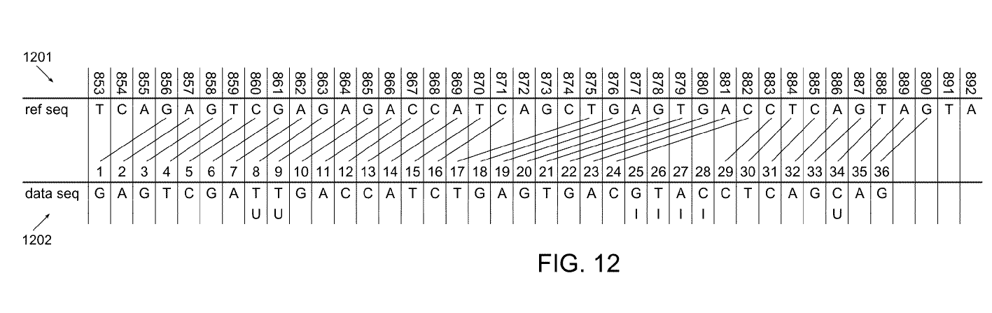

FIG. 12 illustrates an example where a data sequence 1202 of 36 bases is mapped on a reference data sequence 1201. The data sequence is stored in the data storage structure in the following way. First, the length, 36 bases, is stored with the read index and bit-mask field 301 and 302 at reference position 856. Secondly, a mutation data record is created which is a stream of fields with the following data:

Dist=7; Call_Type=UPD X; Call_Data=2,TT,2 Quality Values;

Dist=9; Call_Type=DEL; Call_Data=3;

Dist=8; Call_Type=IN #; Call_Data=4,GTAC,4 Quality Values;

Dist=5; Call_Type=UP C; Call_Data=1 Quality Value.

The data storage structure shown in FIG. 2 could be stored as one single file. However it is also possible that each section or combination of data section and index section are stored as separate files.

From the detailed description of the storage data structure above, a skilled person could easily develop a computer implemented method of storing in the described format of the present application for storing a multitude of sequences which generates the necessary sections, storage section records, count values, data streams, bit-masks, presence indicators, indexes, lookup tables, etc. Similarly, a skilled person could easily develop a computer implemented method of reconstructing a multitude of sequences from the described storage data structure.

The present application describes a method of storing/reconstructing in/from a storage data base a multitude of sequences. The method of storing is a combination of encoding and compression. The method of reconstructing is a combination of decoding and decompression. The storage data structure is such that the response time to reconstruct sequences from a desired position range of the reference data sequence is short for viewers, re-alignment, variant calling and other known post processing tools.

While the invention has been described in terms of several embodiments, it is contemplated that alternatives, modifications, permutations and equals thereof will become apparent to those skilled in the art upon reading the specification and upon study of the drawings. The invention is not limited to the illustrated embodiments. Changes can be made without departing from the idea of the invention.

1. A computer implemented method of storing in a storage data structure (10) a multitude of genetic sequences that have been aligned with a reference data structure, the reference data structure describes genetic reference data as one contiguous reference sequence wherein each element of the reference sequence has a position number and element value, a genetic sequence comprises a number of elements with element values that matches a part of the reference sequence, the part of the genetic reference sequence having a corresponding reference position, the method comprising:
storing a first parameter in a header section (100) of the data structure, the first parameter identifying the reference data structure;
storing in a first storage section (101) of the storage data structure data about the reference position and the number of elements for each sequence of the multitude of sequences; and
storing mutations of the multitude genetic sequences in a second storage section (102) of the storage data structure;
the first storage section (101) comprises a multitude of first storage section records (304, 304A), a first storage section record is associated with at least one sequence which has a corresponding reference position and, the first storage section record further comprises for each of the at least one sequence a length field (402, 406) with a value which enables to determine the number of elements of the at least one sequence, wherein the method further comprises:
counting the sequences having the same reference position to obtain a count value; and
generating a data stream by concatenating the count value (303) and the first storage section records (304, 304A) corresponding to the genetic sequences that have the same reference position.

2. The method according to claim 1, wherein the data corresponding to the multiple of genetic sequences is ordered in the first storage section and second storage section by the reference position of the genetic sequences.

3. The method according to claim 2, wherein the position numbers of the reference sequence are segmented in non-overlapping blocks with a position range of S position numbers, the method generates for each block that has at least one sequence with a reference position in the position rang of said block a data stream (300) wherein a course presence indicator (301) and a fine presence indicator (302) is present in the data stream before a first storage section record (304, 304A), the fine presence indicator indicates for each of F subsequent reference positions the presence of at least one sequence, the course presence indicator indicates for each group of C subsequent groups of F subsequent reference positions the present of at least one sequence in said group of F subsequent reference positions and wherein S=F×C.

4. The method according to claim 1, wherein the position numbers of the elements of the reference sequence are segmented in non-overlapping sections with a position range of P positions, the method further comprises:
generating a first storage section index (200) wherein each section of P positions that has at least one sequence with a reference position in the position range has an entry;
generating a segment data stream (300) comprising the first storage section records (304, 304A) of the sequences having a reference position in a section of P positions;
storing the segment data stream at an address in the storage data structure; and, assigning the address (202) to the entry of the index corresponding to the section of P positions.

5. The method according to claim 4, wherein the method further comprises:
determining for a segment data stream the position of the sequence having the lowest reference position; and
assigning a relative position value corresponding to the lowest reference position to the entry of the index corresponding to the section of P positions.

6. The method according to claim 1, wherein the method further comprises:
storing a second parameter in the header section of the data structure, the second parameter enabling to obtain a value for a basis length of a sequence; and wherein the number of elements of a sequence corresponds to the value of the basis length minus the value of the length field.

7. The method according to claim 1, wherein a record (304) in the first storage section further comprises a first format field (401) prior to the length field (402) for storing a first parameter identifying the number of bits of the length field (402).

8. The method according to claim 1, wherein the method comprises to store a first sequence and a second sequences which form a pair of sequences:
generating a first storage section record (304) comprising a first length field (402), a second length field (406) and a gap field (404), the first length field and the second length field having a value defining the number of elements of the first and second sequence respectively and the gap field having a value defining the difference between the reference position of the first sequence and the reference position of the second sequence.

9. The method according to claim 8, wherein the position numbers of the elements of the reference sequence are segmented in non-overlapping sections with a position range of P positions and wherein the method further comprises:
generating an additional first storage section record for the second sequence in the segment data stream of the section of P positions comprising the reference position of the second sequence if the reference position of the second sequence is located in another section of P positions than the section of P positions associated with the reference position of the first sequence.

10. The method according to claim 9, wherein the additional first storage section record is preceded by a format field and a length field, and the combination of a predefined value of the format field and a predefined value of the length field indicates that the following data is an additional first storage section record.

11. The method according to claim 1, wherein if the contiguous sequence of elements of the reference data structure does not have a sequence part of elements that fully matches a sequence the method comprises:
storing for the sequence in a second storage section (103) of the storage data structure a second storage section record (503), the second storage section record describing the sequence in terms enabling to reconstruct the element values of the sequence by retrieving the element value of the elements that have a matching position in the reference data structure from the associated position in the sequence of reference data structure and the element values of the elements of the sequence that does not have a matching position from the second storage section record (503).

12. The method according to claim 11, wherein the second storage section record comprises a first field (601) identifying the position of a mutation in the sequence and a second field (602) identifying the type of mutation.

13. The method according to claim 12, wherein second storage section record comprises a third field (603) containing the quality of the elements which value differs from the reference

14. The method according to claim 10, wherein the position numbers of the elements of the reference sequence are segmented in non-overlapping sections with a position range of P positions and wherein a sequence comprises an initial sequence part having a reference position in a first section of P positions and a subsequent fragment sequence part having a reference position in a second section of P positions, the method further comprises:
generating an additional first storage section record for the fragment sequence part in the second section of P positions.

15. The method according to claim 1, wherein each element of a sequence has a quality value, the method further comprises:
determining for each position number of the reference data sequence the highest quality value of the elements of the multitude of sequences that has been mapped on said position number; and
generating a third storage section (105) with an index (106) that enables retrieving the highest quality value for each position number from the storage section (105).

16. The method according to claim 15, wherein a quality value could have four different values and the position numbers of the reference sequence are segmented in non-overlapping blocks with a position range of Q position numbers, the method further comprises for each block of Q position numbers that has at least one element of the multitude of sequences mapped on the position range:
determining the most common quality value;
generating a first data structure (702) identifying all positions having the most common quality value;
generating a second data structure (703) identifying all positions not having the most common quality value and the lowest quality value;
generating a quality value stream (704) identifying the quality values of all positions not having the most common quality value and the lowest quality value; and
storing in the third storage section a stream of data that is a concatenation of a field (701) with a value representing the most common quality value, the first data structure (702), the second data structure (703) and the quality value stream (704).

17. The method according to claim 1, wherein each sequence of the multitude of sequences comprises a sequence identifier, wherein the method further comprises:
storing the sequence identifiers in a fourth storage section (107) drat differs from the first storage section (101).

18. The method according claim 17, wherein the sequence identifier is a string of characters with fields that are separated by a delimiter, a field is one of two type, a first type represents a string of digits, a second type represents a string of characters with at least one letter, wherein the method further comprises:
generating a lookup table comprising at least one entry with a template (1000) describing the field types of the fields of a sequence identifier and entries for each of the different values of the second type fields;
generating for a sequence a fourth storage section record (304), the fourth storage section record comprises a first field (901) with a pointer to the at least one entry with a template describing the field types of the sequence identifier and a number of next fields specified by the template retrieve from the al least one entry of the lookup table, a next field (901 . . . 908) identified by the template as first type field contains a number corresponding the string of digits and a next identified by the template as second type field contains a pointer to the entry of the lookup table comprising the string of characters with at least one letter.

19. A computer implemented method of reconstructing a sequence that have been aligned with a reference data structure from a storage data structure, the sequence comprises a number of elements having an element value, the reference data structure describes reference data as one contiguous reference sequence wherein each element of the reference sequence has a position number and element value, the method comprising:
reading a first parameter from a header section of the data structure, the first parameter identifying the reference data structure;
retrieving from a first storage section of the storage data structure a reference position of the sequence on the reference data structure;
retrieving a length value from a length field of a first storage section record, the value enabling to determine the number of elements of the sequence; and,
retrieving the values of the elements of the sequence by reading a part of the contiguous reference sequence which position is defined by the reference position and which length is defined by the length value.

20. The method according to claim 19, wherein the first storage section comprises a data stream that is obtained by concatenating a count value that indicates the number of sequences having the same reference position and the first storage section records corresponding to the sequences that have the same reference position, the method further comprises:
retrieving the count value from the data stream; and,
retrieving the data of N first storage section records, where N corresponds to the count value.

21. The method according to claim 19, wherein the method further comprises:
reading a second parameter in the header section of the data structure, the second parameter enabling to obtain a value for a basis length of a sequence;
subtracting the length value from the value for the basis length to obtain the number of elements of the sequence.

22. The method according to claim 20, wherein the method further comprises:
reading a first parameter identifying the number of bits of the length field from a first storage section record; and,
reading a number of bits corresponding to the first parameter to obtain the value of the length field.

23. The method according to claim 19, wherein the method further comprises to retrieve a pair of sequences from the storage data structure:
determining a first reference position associated with the storage section record by the data structure to access the first storage section record;
reading from first length field, a second length field and a gap field from the first storage section record a first length value, a second length value and a distance value;
reconstructing a first sequence by reading a part of the contiguous reference sequence which position is defined by the first reference position and which length is defined by the first length value;
adding distance value to the reference position to obtain a second reference position associated with a second sequence; and,
reconstructing the second sequence by reading a part of the contiguous reference sequence which position is defined by the second reference position and which length is defined by the second length value.

24. The method according to claim 19, wherein the method is configured to reconstruct a sequence by combining element values retrieved from the contiguous reference sequence and element values retrieved from a second storage section comprising all mutations of the sequence with respect to the reference sequence.

25. The method according to claim 19, wherein the method further comprises retrieving the quality values associated with elements of the sequence which values have been retrieved from the reference sequence from a third storage section which assigns one quality value to a position of the reference sequence.

26. The method according to claim 22, wherein the method detects a predefined combination of first parameter value and value of the corresponding length field as a fragment read and processes sequence associated with the following length information accordingly.

27. (canceled)

28. (canceled)

29. (canceled)

30. (canceled)
